(19) United States
(12) Patent Application Publication
(10) Pub. No.: US 2023/0073922 A1
(43) Pub. Date: Mar. 9, 2023

(54) ONLINE LICENSING PLATFORM COMPRISING SEARCHABLE DATABASE LISTING OFFER OF SUBSCRIPTION FOR FUTURE PURCHASE OF GOODS PRODUCED UNDER AMATEUR-ATHLETE-ISSUED LICENSE FOR USE OF NAME, AND/OR IMAGE, AND/OR LIKENESS (NIL)

(71) Applicant: James BEECHAM, West Palm Beach, FL (US)

(72) Inventor: James BEECHAM, West Palm Beach, FL (US)

(21) Appl. No.: 17/854,832

(22) Filed: Jun. 30, 2022

Related U.S. Application Data
(63) Continuation-in-part of application No. 17/470,193, filed on Sep. 9, 2021, now abandoned.
Application No. 17/470,193 is a continuation-in-part of application No. 17/582,875, filed on Jan. 24, 2022, now abandoned.
Application No. 17/582,875 is a continuation-in-part of application No. 17/825,917, filed on May 26, 2022.
Application No. 17/825,917 is a continuation-in-part of application No. 17/844,221, filed on Jun. 20, 2022.

(51) Int. Cl. G06Q 30/06; G06Q 50/18

(52) U.S. Cl. CPC G06Q 30/0609; G06Q 30/0625; G06Q 50/184

(57) ABSTRACT

Computerized system comprising online platform comprising licensing and subscribing, said licensing regarding license for use of name, and/or image, and/or likeness (NIL), said subscribing regarding subscription for future purchase of goods produced under NIL license issued by amateur athlete. Said computerized system comprises searchable database comprising listing of subscription searchable by user entering search criteria. System optionally comprises display of goods associated to said subscription offer. Such goods optionally comprise at least one of sports card, bobblehead athlete-lookalike. signed ball, electronic badge, signed apparel, jersey, shoes, pants, hat, poster, signage, tickets, sports equipment, sports memorabilia.

### CROSS-REFERENCE TO RELATED APPLICATIONS

The present application is a continuation in part application to U.S. Non-Provisional application Ser. No. 17/470,193 filed 9 Sep. 2021 entitled ‘METHOD AND SYSTEM FOR SPORTS ATHLETE SELLING USE-OF-NAME LICENSE TO FAN TO ENABLE DISPLAY OF SAID ATHLETE NAME IN AD ENDORSEMENT OF TEAM SPIRITEDNESS OF SAID FAN ON SAID FAN SOCIAL MEDIA PAGE’, and to non-provisional application Ser. No. 17/582,875 filed 24 Jan. 2022 entitled ‘ONLINE LICENSING PLATFORM WITH ADDITIONAL FEATURES’, and to non-provisional application Ser. No. 17/825,917 filed 26 May 2022 entitled ‘ONLINE LICENSING PLATFORM COMPRISING PRE-AUTHORIZATION BLOCK, RATINGS OF ATHLETES’ PLATFORM-RELATED ACTIVITIES, LINK TO VIEW AMATEUR ATHLETE ONLINE SOCIAL MEDIA POSTS, AND LIVE STREAMING′, and to non-provisional application Ser. No. 17/844,221 filed 20 Jun. 2022 entitled A COMPUTERIZED SYSTEM AND METHOD FOR IMPROVING EFFICIENCY OF SALE AND PURCHASE OF NAME, IMAGE AND LIKENESS (NIL) LICENSES, the disclosures of which are hereby incorporated in their entirety at least by reference.

### BACKGROUND OF THE INVENTION

### 1. Field of the Invention

The present invention generally relates to online licensing platform comprising searchable database listing offer of subscription for future purchase of goods produced under amateur-athlete-issued license. More specifically, said license references use of said athlete's name, and/or image, and/or likeness (NIL).

### 2. Description of Related Art

Prior art may include 20160196590 A1 by Morgan, 20130246633 A1 by Giesen, and 20190220882 A1 by Fojtik.

### BRIEF SUMMARY OF THE INVENTION

One embodiment of present invention comprises online licensing platform comprising searchable database comprising and/or listing offer of subscription for future purchase of goods produced under license, said license at least referencing use of name, and/or image, and/or likeness (NIL) of at least one amateur athlete. In a preferred embodiment, improvements of efficiency are comprised within said platform. In a preferred embodiment, such improving of efficiency comprises (see FIG. 4) at least one of: more efficient configuring of subscription offer, more efficient populating of subscription offer, more efficient searching for subscription offer, and more efficient implementing of subscription offer.

In a preferred embodiment, instant invention efficient configuring comprises obtaining said license(s) during platform registration, as requirement to be registered. In a preferred embodiment, said efficiency further comprises storing details of said offer within system wherein potential buyers can efficiently access listing/detail by electronic search.

In a preferred embodiment within said platform, discussions by messaging are comprised between athletes. In a preferred embodiment, such messaging assists efficiency, for example in determining which goods are included in such subscription offers. Furthermore, a database is comprised within said platform wherein subscription offers are stored and searchable (see FIG. 1) by potential buyers. Said platform optionally comprises networked computers, such computers linked to non-transitory computer memory, computer processors, and communication links. Said platform is optionally associated to programming configured to accomplish herein disclosed efficiencies.

In a preferred embodiment, a school sports coach registered within said platform is enabled to assist said efficiency. In a preferred embodiment, a coach being co-registered with athletes and fans to said online platform can carry out efficiency-related activities (see FIG. 2) to include on-platform configuring of team roster. Such team roster within said platform is useful for visiting potential buyer to view. In this manner, fans can better understand team of athletes and the athlete-licensed goods on offer by said subscription.

In a preferred embodiment, a database linked to computer of platform has listed details of said subscription offer. In a preferred embodiment, said database is searchable by potential buyer, such as by inputting search criteria (see FIG. 1). In a preferred embodiment, potential buyer on online platform is enabled to execute a search of said database by inputting school name, sport name played by team related to goods on offer, plus inputting gender of team, location by state and zip code of school, such school hosting said team. In a preferred embodiment, searching fan further indicates which athlete group of said team is of interest to fan, such as starting five of basketball team.

In a preferred embodiment, goods within subscription offer can comprise (see FIG. 3) sports cards portraying image of starting five of basketball team of high school. In instant invention, such cards can comprise signature of each athlete, and can comprise profile of athlete with sports-related statistics (see FIG. 3). In a preferred embodiment, efficiency comprises a means for monitoring uptake by subscribing users of said offer of subscription. In a preferred embodiment, efficiency can comprise monitoring and response to user feedback.

In a preferred embodiment, efficiency within instant invention comprises improved coordination of activities of athletes, coach, and fans within platform. For example, athletes of a team can each register to platform, agreeing to license terms as displayed on platform, such agreement required for the athlete's registration and documented therein. Then athletes of team can message to their coach who also is registered in platform, said messages informing coach, by each registered athlete, of their respective registration data with permission to use said data in subscription offers. The fans registered to platform can provide feedback data, such as regards fan searching to system for subscription offers. Such feedback comprises means for adjusting contents of offers.

As background, although subscription for future purchase of goods is well known as a generic, the offering of subscription for future purchase of amateur athletes' NIL-related goods is currently infrequently used or underutilized. Furthermore, such opportunity can spur amateur athletes to register and post on linked social media as means for interacting with fans. Such increase in fan-amateur athlete interaction can increase chances for underfunded athlete to gain money to pay their bills, thus extending the athlete's likelihood of sports participation.

In a preferred embodiment, efficiency of outreach to fans can comprise actions within platform of registered coach. In a preferred embodiment, coach-hosted infomercial can be displayed on page of website of platform such display comprising auto-play at platform, such display spreading the word to friends and acquaintances of the subscription offer.

The word ‘efficiency’ is defined as ability to accomplish a job with relatively less expenditure of time and effort. The word ‘subscription’ is defined as the action of making or implementing to make an advance payment to receive or participate in something.

In a preferred embodiment, subscription for future purchase of NIL-related goods typically comprises a contract, i.e., wherein buyer supplies method of payment and authorization for future billing. In a preferred embodiment, subscription is auto renewable. Such future purchase of goods can be annual set of sports cards of starting five of school's girls' basketball team.

In a preferred embodiment, said athletes can be present or future athletes of team. For example, a recruit arriving next season can be part of the starting five in subsequent years, and wherein subscription is for starting five cards, then such recruit will be included during years when playing on starting five. In a preferred embodiment, said ad makes clear that the athletes share financially in the subscription monies subscribers pay.

In a preferred embodiment for improving system efficiency, such display or ad is viewable by subscription-minded fans visiting platform. A subscription-minded fan can be one who is predisposed to having an interest in particular amateur sports team, such as a longtime fan of said specific team at a specific school and/or an alum of said school.

In a preferred embodiment for improving efficiency, said subscription-minded fan comprises a sports fan who, if efficiently served, would be inclined to purchase a subscription for annual purchase and delivery of sports memorabilia regarding said amateur athletic team. In a preferred embodiment, said subscription-minded fan is attracted to platform via outreach linked to platform. In a preferred embodiment, said linked outreach to such alums uses Mailchimp templates and alumni email addresses.

It is understood that time and effort is required to configure, populate, and implement the subscription offers of a school sports team. Even a subscription-minded alum would have difficulty in configuring such goods to buy if not compiled to convenient purchase as herein disclosed. It is understood that even a subscription-minded alumnus would further have difficulty arranging NIL licenses with amateur athletes on the current team or future teams. It is understood that most even wealthy alums, school sports fans, would likely not be interested to devote their time to such efforts of licensing, promoting, and producing memorabilia.

In a preferred embodiment, efforts disclosed for improving efficiency of platform, by contrast offer efficient subscription service to the fans of virtually all school teams, such as in a conference, or even across the USA. In a preferred embodiment, instant invention's improved efficiency platform with efficiencies of configuring, populating, enabling user searches, and implementing feedback, allows otherwise busy alums to conveniently obtain goods via subscription.

The said efficiencies can not only provide money to the various participating amateur athletes, but simultaneously by instant invention's use as a central focus for subscription offers comprising NIL-related goods, can improve the overall popularity of school sports. As such, and especially where inadequate supply of these goods is meeting needs today, such a central increasingly more renown site can be self-reinforcing in efficiency to a wider sports fan pubic.

In a preferred embodiment, efficiency-improving measures for system/platform can comprise a means for fans feedback to influence offering of goods within future configuring of offers for subscription. In a preferred embodiment, feedback from fans is evaluated by administration of platform. Such feedback can highlight need to offer All-conference card collections, for example.

In a preferred embodiment for improving efficiency, such goods deliveries can continue each season and over a decade or more. In a preferred embodiment, subscribers are offered opportunity to gift a subscription to a family member or friend, with feedback card returned bearing wishes of said family member or friend regards content from choice list.

In a preferred embodiment for improving efficiency, a trading card goods for an amateur athlete can comprise on sports card produced, a social media link for said athlete. Such link can potentially provide subscriber with updates about the player in future years, even as athlete graduates from school but continues to post to said linked account.

In a preferred embodiment for improving efficiency, team former coach of amateur athletes can host at online platform a live-streamed event explaining subscription offer to potential subscribers. In a preferred embodiment, said event can include display of former team roster and film highlights from earlier games.

In a preferred embodiment for improving efficiency, video supporting offer of goods by subscription can comprise terminology as at least one of: varsity, junior varsity, offense, defense, lineman, quarterback, safety, receiver, point guard, shooting guard, center, forward, soccer, football, basketball, volleyball, track and field, golf, tennis, swimming, gymnastics, high school, college, university. In a preferred embodiment, goods on offer by subscription within instant invention can comprise one or more of trading card, bobblehead athlete-lookalike, signed baseball, electronic badge, signed apparel, signed jersey, signature shoe, pants, hat, sticker, poster, signage, tickets, sports equipment, sports memorabilia.

In a preferred embodiment for improving efficiency, offer of goods by subscription can reference, by school's permission, one or more of the schools which serve respectively as base for teams of amateur athletes related to said goods. In a preferred embodiment for improving efficiency, offer of goods by subscription can reference and display school name and school image and school mascot.

In a preferred embodiment for improving efficiency, offer of goods by subscription can comprise a team-signed ball, such as basketball or football. In a preferred embodiment, said ball is optionally decorated with reminders of honors accrued, such as conference champion, or the like if achieved that season.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is an illustration of a page display of online platform of a preferred embodiment.

FIG. 2 is a schematic of a preferred embodiment.

FIG. 3 is a schematic of a preferred embodiment.

FIG. 4 is a chart of a preferred embodiment.

FIG. 5 is a table of a preferred embodiment.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art since the general principles of the present invention have been defined herein to specifically provide efficient online licensing platform comprising searchable database listing offer of subscription for future purchase of goods produced under amateur-athlete-issued NIL license.

The word “a” is defined to mean “at least one.” The word ‘efficiency’ is defined as ability to accomplish a job with relatively less expenditure of time and effort.

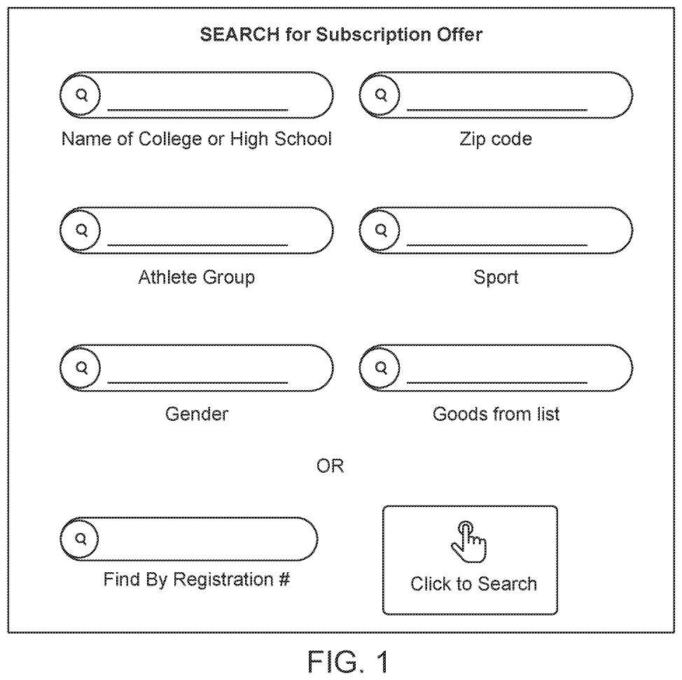

FIG. 1 is an illustration of a page display of online platform of a preferred embodiment. The page comprises a search request form allowing user to enter search terms and execute a search of platform database to located fan-desired school team related offers for subscription to purchase NIL-related goods. At top left, the name of school sought by user is entered. At top right the zip code of school's location is entered. At middle right the user enters the name of the sport the fan-desired team plays at the school. At the middle left, user enters athlete group, such as starting five of basketball team, or defensive line of school football team. At bottom left, user enters the gender of athletes on team, such as female for the girls' volleyball team. At bottom right, user enters goods sought, such as from dropdown list. List can comprise choices such as ‘all available’ or ‘sports cards.’ Optionally, where user knows the registration number of the subscription offer sought, user can go directly to bottom left of page, enter that offer number in space provided and click search. After inputting criteria, user clicks to execute the search.

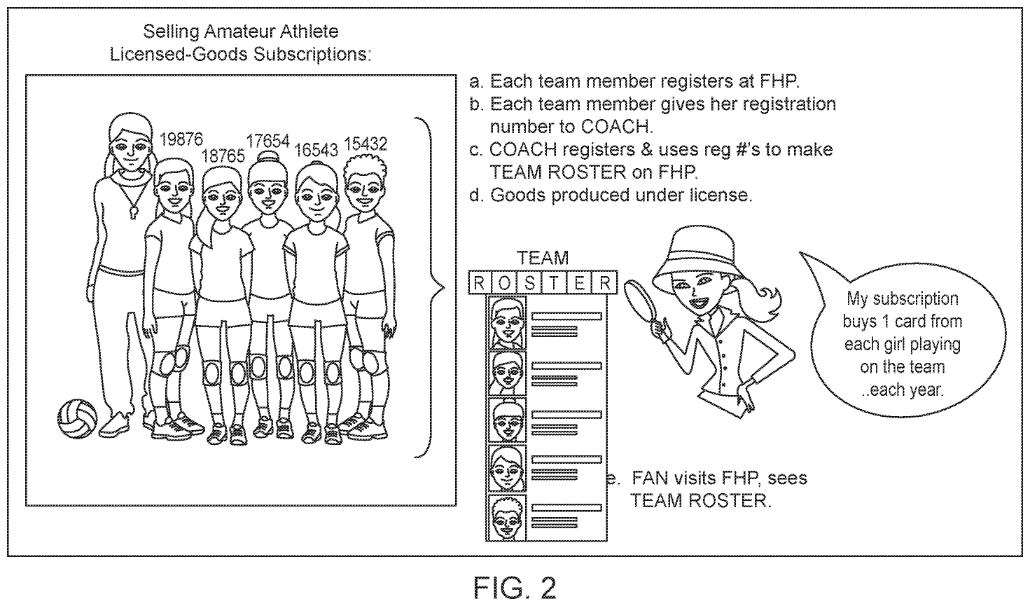

FIG. 2 is a schematic displaying a preferred embodiment of instant invention wherein efficiencies are applied within instant invention online licensing and subscribing platform. Such efficiencies can be regarding configuring offer, and/or populating offer. To the left is depicted a girls' school basketball team's starting five players with coach. Above each starting player's head is a number representing their registration number in the instant invention online platform. By platform system for messaging, coach can be informed by each player supplies her registration number to coach. Coach can use this information to compile a team roster, such as roster of starting players (roster is schematically depicted in lower middle aspect of FIG. 2). Said roster is typically visible to Fan visiting the platform. The Fan (shown at right of FIG. 2 as woman Fan with magnifying glass which indicates her interest to examine roster), within online platform, can click to view each girl's profile. Fan can search and find and examine the subscription offer details in efficient manner. The registration of the coach at the same platform as the players and the fan is enabled to accomplish efficiencies as herein disclosed. For example, coach can familiarize himself or herself with the platform, can thus verify that platform meets the needs of the team, such as safeguarding athletes' amateur status. Furthermore, coach can read the displayed terms of athlete providing rule-compliant photo and video. Coach can verify appropriateness of license agreement displayed on platform, such as by comparing said terms to requirements of the specific school hosting the said team. Where this school-specific review satisfies coach that site is beneficial to her team, this assessment allows coach to knowledgably recommend site to other amateur athletes of his team and to other coaches at her school and conference. Further, coach can recommend platform services to fans and to school officials. Such recommending by coach comprising another means for boosting efficiency in subscription offer uptake within instant invention. To also view and evaluate said online displayed license agreements of platform, the team Coach can invite a legal advisor representing the athletes to visit the site. To view and evaluate said online displayed license agreement terms, the team Coach can also invite, to view the platform, a representative of the school where the team is based. Based on the feedback coach receives from these advisors, and using coach's own knowledge and judgement, the coach can guide the team and the school and the sports fans to devote their respective activities to enable efficiencies with the platform. Such efficiencies as herein disclosed can work for the benefit of the team and of the school, thus boosting reputation of site's offer of subscription.

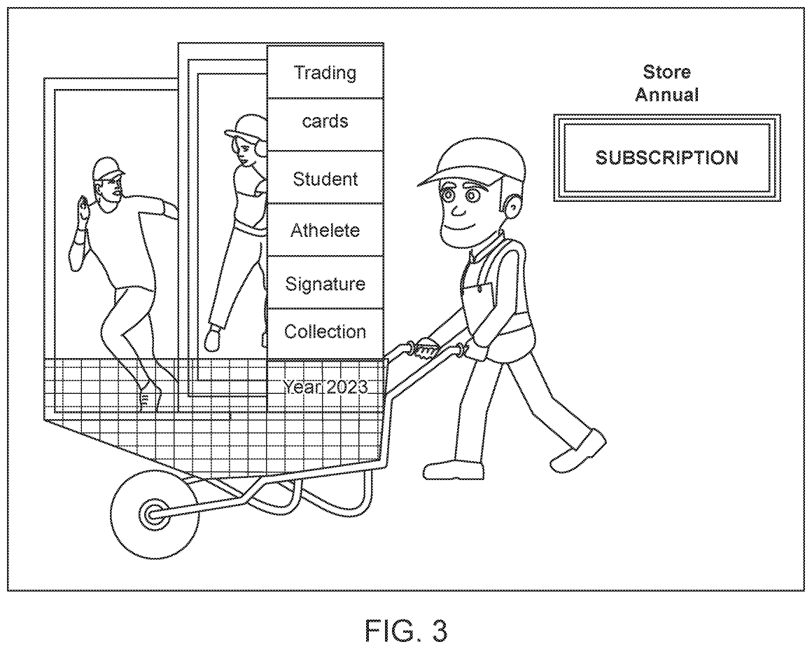

FIG. 3 is a schematic which depicts online store (under construction) linked to instant invention platform. Within the schematic of the store are displayed trading cards, the purchase of which comprise store's offer for subscription. Schematic as platform ad, can also serve as depiction of a delivery service connected to said online platform of instant invention (the man with the wheelbarrow is the delivery service in the ad). The sports cards depicted are of an amateur baseball team, the athletes and coach of said team registered at platform. The sports cards depicted have signature on card, each reflecting the signature of the athlete profiled on the card. The year of the team cards is 2023, a year not yet arrived at the time of the writing of this specification in 2022. Thus, the future is depicted in these cards year of reference, such display as a means of allowing the buyer to efficiently understand the future nature of the subscription contract on offer. The sign at the Store (top right of FIG. 3) indicates an annual subscription contract is offered.

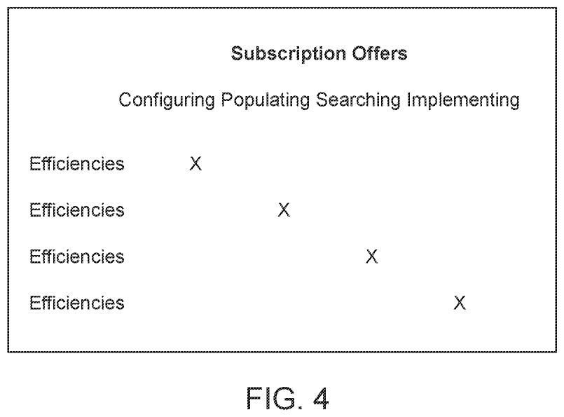

FIG. 4 is a chart of a preferred embodiment, said chart illustrating concept that efficiencies within instant invention can be regarding subscription offer as cumulative and/or multiplicative, i.e., synergistic. For example, an efficiency within instant invention disclosure which efficiency primarily deals with the improving configuring of a subscription offer, said efficiency can multiply the benefit of an efficiency primarily dealing with searching efficiently for subscription offer. Thus, for example, an efficiently configured subscription offer, when found easily by customer via efficient search, such combination can multiply uptake of said subscription offer.

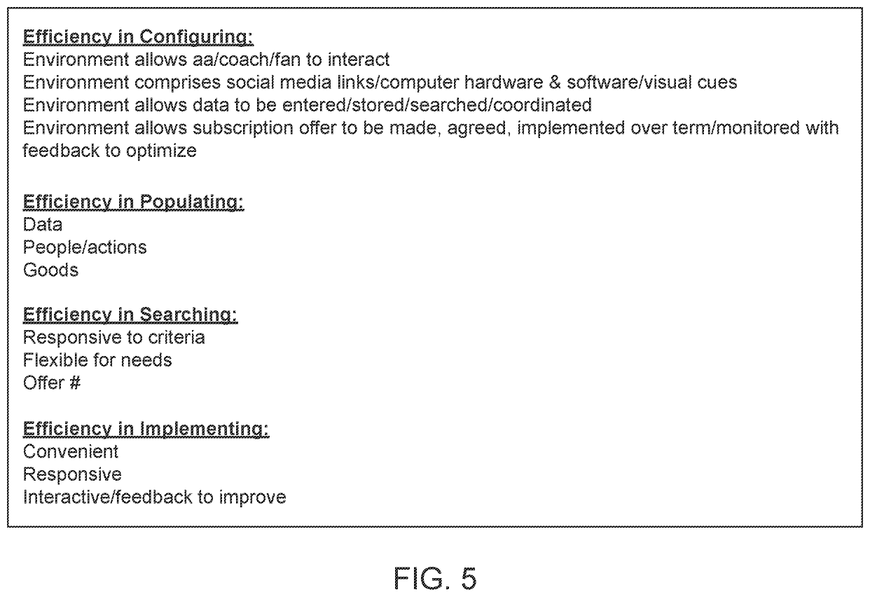

In FIG. 5, a table lists areas within instant invention for which disclosures provide details of means for improving efficiency of instant invention offering of subscription. Such improvements optionally comprise an efficient messaging environment within platform of instant invention. Similarly, efficient linking of athlete social media posts to view of visiting fans boosts likelihood fan will develop an interest in athlete and the subscription offers wherein athlete is featured.

In a preferred embodiment of configuring, a bulletin board is hosted on platform by administration, such bulletin board informing registered users of news. Such bulletin board can inform registered users of propose new configurations of subscriptions and survey their feedback. Such new configuration can comprise an all-conference team set of sports cards, or a Rookie of the year signed ball.

In a preferred embodiment, bulletin board can host input from providers of memorabilia production, such as card printer and apparel makers. Optionally, providers can respond to posts of coach or athlete or fan within platform, thus furthering discussion of proposed subscription products. In a preferred embodiment, a bidding process can be instituted on platform bulletin board for finding producer offering best price for producing subscription-based goods.

In FIG. 5, efficiency in Implementing for subscription offer can comprise, in a preferred embodiment, outreach via email messaging to Athletic Departments of conference and/or to fan groups of school boosters. Such outreach can comprise providing links by which access to instant invention platform and discussions about pending subscription deals is available for returning feedback. In a preferred embodiment, conference teams and fan groups can request samples of goods offered by subscription. Such samples can comprise hologram-marked collectables wherein hologram can certify authenticity. Among the sample sent can be bobblehead athlete-lookalikes.

In FIG. 5, efficiency in Searching for subscription offer can comprise instant search results. Feedback from users and Chat help are disclosed as efficient options, such as where AI powered bot asks: “Did you find what you were looking for?” and then an interactive chat follows to educate user about the system. Furthermore, the details of what users do not understand or could not find are useful in improving the means for using feedback. A number system is disclosed for offers, making search request easier for user. An option comprises identifying search trends.

In FIG. 5, efficiency in Implementing for subscription offer can comprise means for efficient tracking and feedback wherein trends are analyzed. A rating system by five stars for best rating, can comprise feedback for area of user convenience, and for overall satisfaction. Said rating system is optionally presented to users for use after user subscribing. A system form, such as free form or fill-in-the-blank form, comprises survey allowing system user to indicate what they liked about the system and what they did not like. Use of data from such surveys can further improve efficiency of licensing, subscription, and offering of goods within platform.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention

Reference to “first,” “second,” “third,” and so forth members throughout the disclosure (and in particular, claims) are not used to show a serial or numerical limitation but instead are used to distinguish or identify the various members of the group.

What is claimed is:

1. A system comprising an online licensing platform comprising searchable database comprising offer of subscription for future purchase of goods produced under license, said license for use of at least one of name, image, and likeness (NIL) of at least one amateur athlete.

2. The system of claim 1, further comprising registration within system of at least one of athlete, sports coach, and sports fan.

3. The system of claim 1, further comprising use of store offering at least one of list: trading card, bobblehead athlete-lookalike. signed baseball, electronic badge, signed apparel, jersey, shoe, pants, hat, sticker, poster, signage, tickets, athletic equipment.

4. The system of claim 1, further comprising team roster.

5. The system of claim 1, further comprising agreement requirement during registration.

6. The system of claim 1, further comprising license agreement terms displayed on system.

7. The system of claim 1, further comprising at least one reference to at least one of varsity, junior varsity, offense, defense, lineman, quarterback, safety, receiver, point guard, shooting guard, center, forward, soccer, football, basketball, volleyball, track and field, golf, tennis, swimming, gymnastics, high school, college, university.

8. A system comprising online licensing and subscribing platform, said licensing regarding use of at least one of name, image, and likeness (NIL) of amateur athlete, said subscribing regarding future purchase of goods licensed by amateur athlete.

9. The system of claim 8, further comprising goods produced under license.

10. The system of claim 8, further comprising search criteria comprising at least one of school name and sport name.

11. The system of claim 8, further comprising at least one of trading card, bobblehead athlete-lookalike. signed baseball, electronic badge, signed apparel, jersey, shoe, pants, hat, sticker, poster, signage, tickets, athletic equipment.

12. A system comprising online subscribing platform comprising display of sports memorabilia offered for future purchase by subscription, said goods produced under license comprising use of at least one of name, image, and likeness (NIL) of at least one amateur athlete.

13. The system of claim 12, further comprising electronic search for subscription offer.

14. The system of claim 12, further comprising auto-renew subscription.

15. The system of claim 12, further comprising profile of at least one athlete.

16. The system of claim 12, further comprising team roster.

17. The system of claim 12, further comprising outreach to school alumni.

18. The system of claim 12, further comprising means for requiring amateur athlete, during registration, to agree to terms of said license, and documenting said agreeing.

19. The system of claim 12, further comprising at least one reference to at least one of varsity, junior varsity, offense, defense, lineman, quarterback, safety, receiver, point guard, shooting guard, center, forward, soccer, football, basketball, volleyball, track and field, golf, tennis, swimming, gymnastics, high school, college, university.

20. The system of claim 12, further comprising display of goods comprising at least one of list: trading card, bobblehead athlete-lookalike. signed ball, electronic badge, signed apparel, jersey, shoe, pants, hat, sticker, poster, signage, tickets, athletic equipment, sports memorabilia.
